(19) United States
(12) Patent Application Publication
(10) Pub. No.: US 2020/0263269 A1
(43) Pub. Date: Aug. 20, 2020

(54) CONTINUOUS WORKING SYSTEM WITH HANGING CONVEYER

(71) Applicant: King Yuan Dar Metal Enterprise Co., Ltd., Changhua (TW)

(72) Inventor: Chang Lung TSENG, Changhua (TW)

(21) Appl. No.: 16/276,660

(22) Filed: Feb. 15, 2019

(51) Int. Cl. C21D 9/00; F27B 9/04; F27B 9/24

(52) U.S. Cl. CPC C21D 9/0062; F27B 9/2453; F27B 9/04; C21D 9/0018

(57) ABSTRACT

A working system includes two or more container which are manufactured separately and previously and then moved to the factories or working plants, and then assembled into the continuous working system in the factories or working plants, for allowing the working system to be easily manufactured and assembled and moved or transported to the required places or positions. The containers each include one or more working zones and an aisle for entering into the working zones selectively. Two of the containers are arranged opposite to each other and parallel to each other, and the other containers are arranged opposite to and parallel to each other and disposed between the other two containers.

### BACKGROUND OF THE INVENTION

### 1. Field of the Invention

The present invention relates to a working system or facility or station or assembly, and more particularly to a high temperature and continuous furnace or working system or station or assembly including a number of units or containers that may be easily manufactured and assembled into the continuous working system, and the containers each include one or more heating zones, carburizing zones, heat treating zones, powder metallurgy zones, diffusing zones, cooling zones, and/or the like.

### 2. Description of the Prior Art

Typical heating furnaces or working systems or facilities or stations or assemblies comprise a number of working stations or operating zones that are separated from each other, or disposed or located close to each other for heating, carburizing, heat treating, powder metallurgy, diffusing, quenching, cooling operation, and/or the like.

U.S. Pat. No. 7,029,625 to Shimosato et al., U.S. Pat. No. 7,520,746 to Johnston et al., U.S. Pat. No. 8,298,475 to Tseng, and U.S. Pat. No. 9,523,136 to Tseng disclose several of the typical furnace product supporting or transporting devices for supporting or transporting the typical high chromium steel materials or plates into and out of the typical steel furnaces.

However, the typical furnace product supporting or transporting devices may comprise a number of working stations or operating zones that may not be easily manufactured, and should be manufactured and assembled into the continuous working system in the factories or working plants, but the working stations or operating zones may not be easily manufactured separately and then moved to the factories or working plants, and then assembled into the continuous working system in the factories or working plants.

The present invention has arisen to mitigate and/or obviate the afore-described disadvantages of the conventional furnace or working systems or assemblies.

### SUMMARY OF THE INVENTION

The primary objective of the present invention is to provide a continuous furnace or working system or station or assembly including a number of units or containers that may be easily manufactured and assembled into the continuous working system, and the containers each include one or more heating zones, carburizing zones, heat treating zones, powder metallurgy zones, diffusing zones, cooling zones, and/or the like, for powder metallurgy operations.

In accordance with one aspect of the invention, there is provided a working system comprising a first container including a first working zone, a second container including a second working zone, a third container including a third working zone, a fourth container including a fourth working zone, and the first container and the second container and the third container and the fourth container may be manufactured separately and previously and then moved to the factories or working plants, and then assembled into the continuous working system in the factories or working plants, for allowing the working system to be easily manufactured and assembled and moved or transported to the required places or positions.

The first container and the third container are arranged opposite to each other, and the second container and the fourth container are arranged opposite to each other. The first container and the third container are parallel to each other, and the second container and the fourth container are parallel to each other. The first container and the third container are perpendicular to the second container and the fourth container. The second container and the fourth container are disposed and arranged between the first container and the third container.

The first working zone of the first container is selected from a work piece feeding zone, a product output zone, and an aisle arranged for entering into the work piece feeding zone and the product output zone selectively. The second working zone of the second container is selected from a sintering zone, a blasting zone, a blowing and drying zone, and an aisle arranged for entering into the sintering zone, the blasting zone, and the blowing and drying zone selectively.

The third working zone of the third container is selected from a vibrating and grinding zone, and an aisle arranged for entering into the vibrating and grinding zone selectively. The fourth working zone of the fourth container is selected from a cleaning zone, an annealing zone, an inspecting zone, and an aisle arranged for entering into the cleaning zone and the annealing zone and the inspecting zone selectively.

A hanging conveyer may further be provided and disposed and arranged in the first and the second and the third and the fourth containers for conveying a work piece through the first and the second and the third and the fourth working zones of the first and the second and the third and the fourth containers.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a top plan schematic and cross sectional view of a working system in accordance with the present invention;

FIG. 2 is another top plan schematic and cross sectional view of the working system, similar to FIG. 1;

FIG. 3 is a top plan schematic view of the working system as shown in FIGS. 1 and 2;

FIG. 4 is a further top plan schematic and cross sectional view similar to FIGS. 1 and 2, illustrating the other arrangement of the working system;

FIG. 5 is a top plan schematic view of the working system as shown in FIG. 4;

FIG. 6 is a side plan schematic view of the working system as shown in FIGS. 1 and 2-3;

FIG. 7 is another side plan schematic view of the working system as shown in FIGS. 4 and 5;

FIG. 8 is a further top plan schematic and cross sectional view similar to FIGS. 1-2 and 4, illustrating the further arrangement of the working system; and

FIG. 9 is a further side plan schematic view illustrating the still further arrangement of the working system.

### DETAILED DESCRIPTION OF THE PREFERRED EMBODIMENT

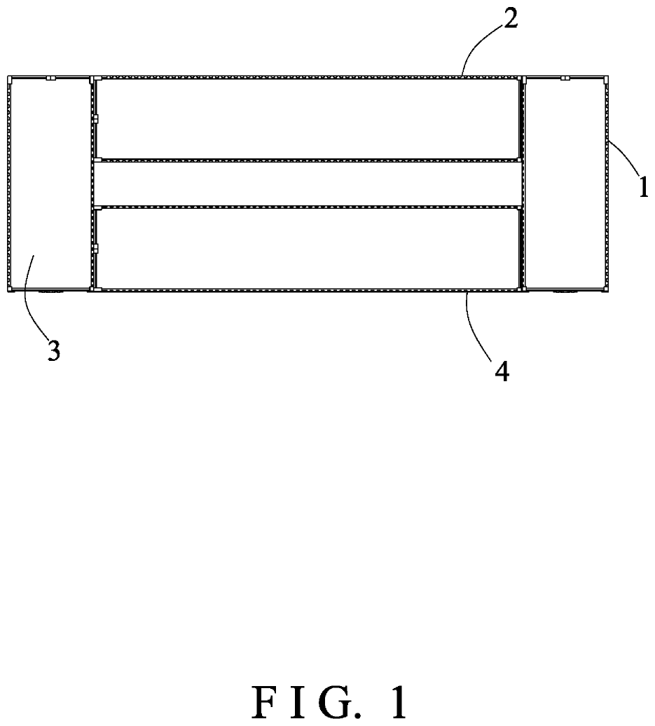

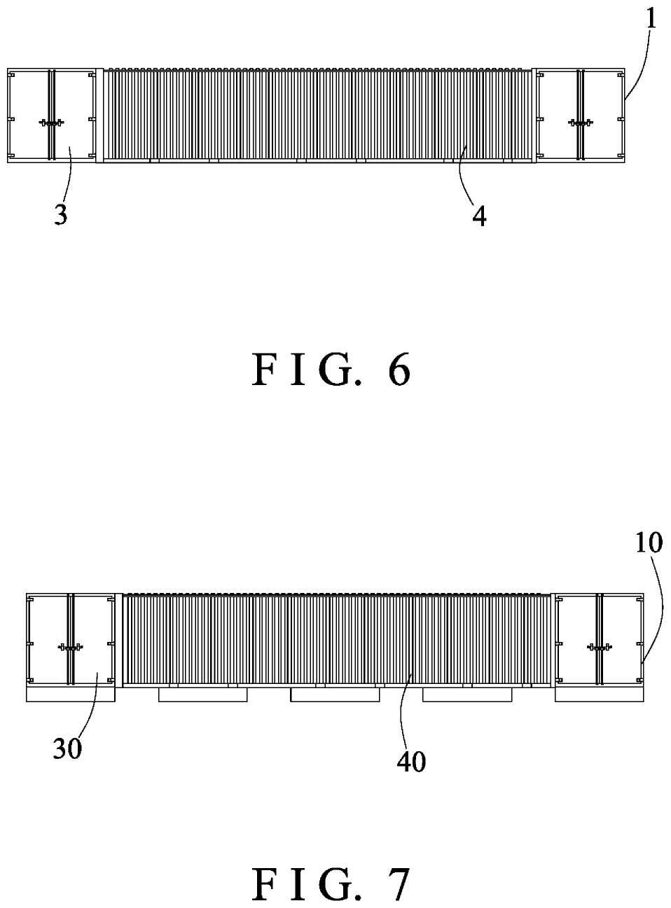

Referring to the drawings, and initially to FIGS. 1-3 and 6, a working system or facility or station or assembly in accordance with the present invention is provided for powder metallurgy operations, for example, and the powder metallurgy operations normally comprise a number of working stations or operating zones, such as work piece preparing and feeding or introducing zone, sintering zone, blasting zone, blowing and drying zone, vibrating and grinding zone, cleaning zone, annealing zone, examining or inspecting zone, product output zone, etc. For example, the working system comprises one or more (such as two) shorter units or containers 1, 3, and one or more (such as two) longer units or containers 2, 4 that may be easily manufactured separately and then moved to the factories or working plants (not illustrated), and then assembled into the continuous working system. The shorter containers 1, 3 and the longer containers 2, 4 each may include one or more working stations or operating zones formed or provided therein.

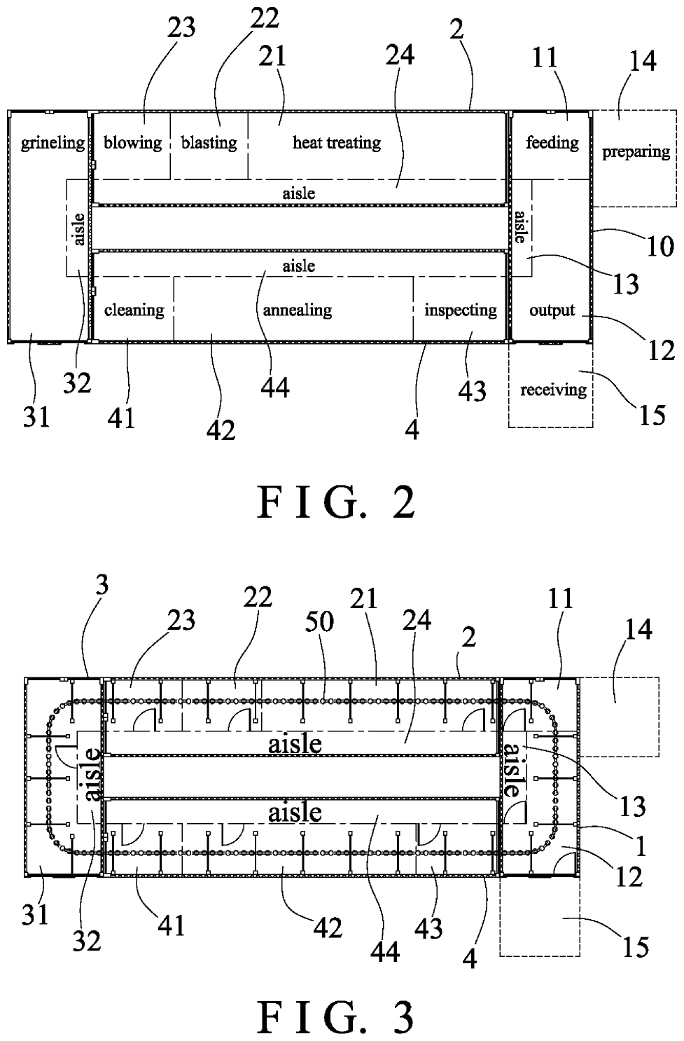

As shown in FIGS. 2 and 3, for example, the first container 1 may be selected from a shorter unit including one or more first working stations or zones, such as a work piece feeding or introducing zone 11, a product output zone 12, and an aisle 13 formed or provided therein and arranged for allowing the user to enter into the work piece feeding or introducing zone 11 and the product output zone 12 selectively. It is preferable that a semi-product or work piece preparing zone 14 may further be provided and disposed and arranged or located close to or beside the work piece feeding zone 11 for providing and supplying the semi-product or work piece to the work piece feeding zone 11, and a product receiving or reception zone 15 may further be provided and disposed and arranged or located close to or beside the product output zone 12 for receiving the product from the product output zone 12.

The second container 2 may be selected from a longer unit including one or more second working stations or zones, such as a sintering zone 21 that may be heated up to about 1150 degrees Celsius, a blasting zone 22 associated or worked with a blaster (not illustrated) or the like, a blowing and drying zone 23, and an aisle 24 formed or provided therein and arranged for allowing the user to enter into the sintering zone 21, the blasting zone 22, and the blowing and drying zone 23 selectively. The third container 3 may be selected from a shorter unit including one or more third working stations or zones, such as a vibrating and grinding zone 31, and an aisle 32 formed or provided therein and arranged for allowing the user to enter into the vibrating and grinding zone 31 selectively. The vibrating and grinding zone 31 may be used for vibrating and grinding the work pieces and for removing burrs or projections from the work pieces.

The fourth container 4 may be selected from a longer unit including one or more fourth working stations or zones, such as a cleaning zone 41 for cleaning the work pieces with a water of 80 degrees Celsius, an annealing zone 42 that may be heated up to about 300 degrees Celsius, an examining or inspecting zone 43 associated or worked with an infrared or electric examining or inspecting facility (not illustrated) or the like, and an aisle 44 formed or provided therein and arranged for allowing the user to enter into the cleaning zone 41 and the annealing zone 42 and the examining or inspecting zone 43 selectively. The higher temperature of about 1150 degrees Celsius in the sintering zone 21 may be selectively supplied or introduced into the annealing zone 42 for preheating the annealing zone 42 and for heat preserving or economizing purposes. The arrangement of the working stations or operating zones formed in the containers 1, 2, 3, 4 as shown in FIGS. 2 and 3 may be provided for powder metallurgy operation or the like.

It is to be noted that the containers 1, 2, 3, 4 may be easily manufactured separately and then moved to the factories or working plants (not illustrated), and then assembled into the continuous working system. It is preferable, but not necessary that the two shorter containers 1, 3 are disposed and arranged opposite to each other and parallel to each other, and the two longer containers 2, 4 are disposed and arranged opposite to each other and parallel to each other, and disposed and arranged between the two shorter containers 1, 3, but perpendicular to the shorter containers 1, 3. Alternatively, the shorter containers 1, 3 may also be disposed and arranged between the two longer containers 2, 4. As shown in FIG. 3, a hanging conveyer 50 may further be provided and disposed and arranged in the containers 1, 2, 3, 4 for feeding or introducing or conveying the work pieces through the working stations or operating zones and for preventing the work pieces from contacting with the ground or the supporting surfaces of the containers 1, 2, 3, 4.

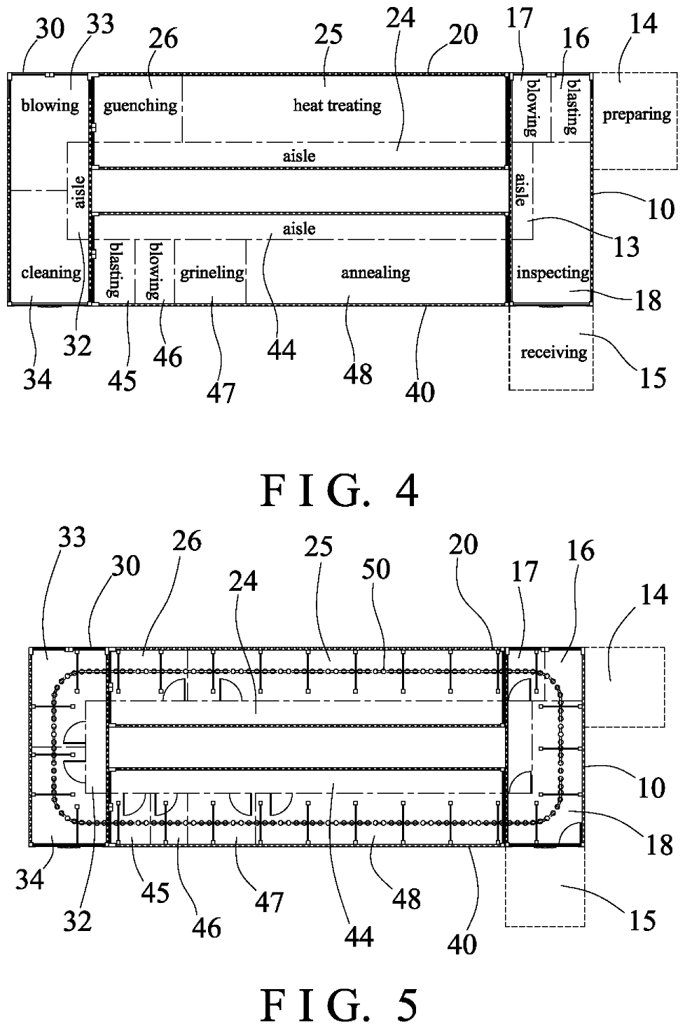

As shown in FIGS. 4-5 and 7, the containers 10, 20, 30, 40 may also be disposed and arranged is a parallelogrammic shape or structure or configuration, and the working stations or operating zones formed in the containers 10, 20, 30, 40 may be arranged in different arrangement. For example, the first container 10 may include a blasting zone 16, a blowing and drying zone 17, and an examining or inspecting zone 18, provided for heat treating purposes, for example, and an aisle 13 formed or provided therein and arranged for allowing the user to enter into the work zones 16, 17, 18 selectively. It is also preferable that a semi-product or work piece preparing zone 14 may further be provided and disposed and arranged or located close to or beside the blasting zone 16 for providing and supplying the semi-product or work piece to the blasting zone 16, and a product receiving or reception zone 15 may further be provided and disposed and arranged or located close to or beside the examining or inspecting zone 18 for receiving the product from the examining or inspecting zone 18.

The second container 20 may include a heat treating zone 25, and a quenching zone 26, and an aisle 24 formed or provided therein and arranged for allowing the user to enter into the heat treating zone 25 and the quenching zone 26 selectively. The third container 30 may include a blowing and drying zone 33, a cleaning zone 34, and an aisle 32 formed or provided therein and arranged for allowing the user to enter into the drying zone 33 and the cleaning zone 34 selectively. The fourth container 40 may include a blasting zone 45, a blowing and drying zone 46, a vibrating and grinding zone 47, and an annealing zone 48, and an aisle 44 formed or provided therein and arranged for allowing the user to enter into the blasting zone 45, the blowing and drying zone 46, the vibrating and grinding zone 47, and the annealing zone 48 selectively. A hanging conveyer 50 may also be provided and disposed in the containers 10, 20, 30, 40 for feeding or introducing or conveying the work pieces through the working stations or operating zones and for preventing the work pieces from contacting with the ground or the supporting surfaces of the containers 10, 20, 30, 40.

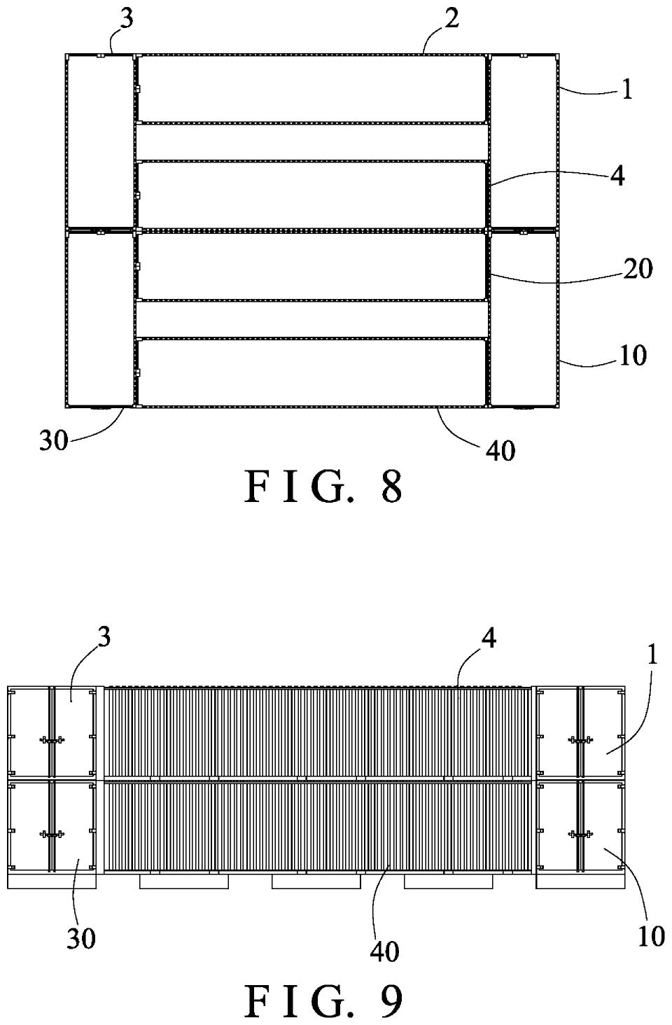

As shown in FIG. 8, the working system as shown in FIGS. 1-3 and 6, and the other working system as shown in FIGS. 4-5 and 7 may also be assembled and/or secured or connected or coupled together, and the containers 1, 2, 3, 4, 10, 20, 30, 40 may also be manufactured separately and previously and then moved to the factories or working plants, and then assembled into the continuous working system in the factories or working plants. Alternatively, as shown in FIG. 9, the working system as shown in FIGS. 1-3 and 6 may also be assembled and disposed or arranged above the other working system as shown in FIGS. 4-5 and 7, and the containers 1, 2, 3, 4, 10, 20, 30, 40 may also be manufactured separately and previously and then moved to the factories or working plants, and then assembled into the continuous working system in the factories or working plants, for allowing the working systems to be easily manufactured and assembled and moved or transported to the required places or positions.

Accordingly, the high temperature and continuous working system in accordance with the present invention includes a number of units or containers that may be easily manufactured and assembled into the continuous working system, and the containers each include one or more heating zones, carburizing zones, heat treating zones, powder metallurgy zones, diffusing zones, cooling zones, and/or the like.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A working system comprising:
a first container including a first working zone,
a second container including a second working zone,
a third container including a third working zone,
a fourth container including a fourth working zone, wherein
said first container and said second container and said third container and said fourth container being manufactured separately and then assembled together.

2. The working system as claimed in claim 1, wherein said first container and said third container are arranged opposite to each other, and said second container and said fourth container are arranged opposite to each other.

3. The working system as claimed in claim 2, wherein said first container and said third container are parallel to each other, and said second container and said fourth container are parallel to each other.

4. The working system as claimed in claim 2, wherein said first container and said third container are perpendicular to said second container and said fourth container.

5. The working system as claimed in claim 2, wherein said second container and said fourth container are disposed and arranged between said first container and said third container.

6. The working system as claimed in claim 1, wherein said first working zone of said first container is selected from a work piece feeding zone, a product output zone, and an aisle arranged for entering into said work piece feeding zone and said product output zone selectively.

7. The working system as claimed in claim 1, wherein said second working zone of said second container is selected from a sintering zone, a blasting zone, a blowing and drying zone, and an aisle arranged for entering into said sintering zone, said blasting zone, and said blowing and drying zone selectively.

8. The working system as claimed in claim 1, wherein said third working zone of said third container is selected from a vibrating and grinding zone, and an aisle arranged for entering into said vibrating and grinding zone selectively.

9. The working system as claimed in claim 1, wherein said fourth working zone of said fourth container is selected from a cleaning zone, an annealing zone, an inspecting zone, and an aisle arranged for entering into said cleaning zone and said annealing zone and said inspecting zone selectively.

10. The working system as claimed in claim 1 further comprising a hanging conveyer disposed and arranged in said first and said second and said third and said fourth containers for conveying a work piece through said first and said second and said third and said fourth working zones of said first and said second and said third and said fourth containers.
